(19) United States
(12) Patent Application Publication
(10) Pub. No.: US 2025/0242837 A1
(43) Pub. Date: Jul. 31, 2025

(54) ADAPTIVE DRIVER INTERFACE USING DRIVER COGNITIVE FACTORS

(71) Applicant: TOYOTA RESEARCH INSTITUTE, INC., LOS ALTOS, CA (US)

(72) Inventors: EMILY SUMNER, Mountain View, CA (US); Jean Marcel Dos Reis Costa, San Jose, CA (US); Tiffany L. Chen, San Jose, CA (US); Andrew P. Best, Sunnyvale, CA (US)

(73) Assignees: TOYOTA RESEARCH INSTITUTE, INC., LOS ALTOS, CA (US); TOYOTA JIDOSHA KABUSHIKI KAISHA, TOYOTA-SHI (JP)

(21) Appl. No.: 18/423,039

(22) Filed: Jan. 25, 2024

(51) Int. Cl. B60W 60/00; B60W 50/14; B60W 50/16

(52) U.S. Cl. CPC B60W 60/0051; B60W 50/16; B60W 2050/143; B60W 2050/146; B60W 2540/30

(57) ABSTRACT

Systems and methods of adapting a driver interface for a vehicle are disclosed. Exemplary implementations may: obtain cognitive factor information corresponding to a driver of the vehicle; and adapt a driver interface of the vehicle based on the cognitive factor information. The adapting of the driver interface includes alerting the driver via an alert using the adaptive driver interface. Systems and methods of adapting control of an autonomous vehicle using cognitive factor information corresponding to a driver of the autonomous vehicle are also disclosed.

### TECHNICAL FIELD

The present disclosure relates generally to controlling operation of an autonomous vehicle, and in particular, some implementations may relate to adapting a driver interface for a vehicle using driver cognitive factors.

### DESCRIPTION OF RELATED ART

Autonomous vehicles, with various levels of automation, have been increasingly playing a significant role in the development of vehicle intelligence technologies. However, the successful use of such assistive technology for improving safety, reducing accidents, and saving lives greatly depends on personal factors influencing the driver's behavior and interaction with such assistive technology. These personal factors include two key cognitive factors, i.e., impulsivity and inhibitory control, which are related to risky driving behavior such as speeding or running yellow lights. However, current assistive technologies do not consider cognitive factor aspects of the driver and instead rely on explicit settings (i.e., not related to cognitive factors) manually entered by the driver to determine and set driver preferences. This poses a challenge, namely, how to provide an adaptive interface based on driver's cognitive factors, ensuring a safe and accident-free driving experience.

### BRIEF SUMMARY OF THE DISCLOSURE

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, method may include obtaining cognitive factor information corresponding to a driver of the vehicle. Method may also include adapting a driver interface of the vehicle based on the cognitive factor information. Method may furthermore include where the step of adapting may include alerting the driver via an alert using the adaptive driver interface. Other embodiments of this aspect include corresponding computer systems, apparatus, and computer programs recorded on one or more computer storage devices, each configured to perform the actions of the methods.

Implementations may include one or more of the following features. Method where the cognitive factor information may include inhibitive control information corresponding to the driver. Method where the inhibitive control information may include an assessed level of inhibitive control of the driver. Method where the alert is adaptable via a parameter selected from the group having of volume, brightness, contrast, color, frequency, timing, intensity, size, shape, and a combination thereof, and where the adaptability of the alert corresponds to the assessed level of inhibitive control of the driver. Method where the alert may include a type selected from the group having of audio, visual, haptic, and a combination thereof. Method where the alert signals the driver to adjust control of the vehicle. Method where obtaining cognitive factor information may include a cognitive factor information acquisition scheme selected from the group having of receiving driving data from monitoring driving behavior of the driver, completing a questionnaire for assessing driving behavior of the driver, and a combination thereof. Method where the driving behavior of the driver may include at least one driving behavior selected from the group having of: propensity to tailgate; reaction to a traffic light; propensity to change lanes; lane preference; frequency of lateral lane position shifting; propensity to speed; propensity to pass vehicles; propensity to cut-off vehicles; propensity to speed around turns; propensity to be first to accelerate at a traffic light or sign; aggressive acceleration; aggressive deceleration; aggressive lane changing; aggressive following distance from vehicle ahead; and a combination thereof. Method where the alert is adaptable via a parameter selected from the group having of volume, brightness, contrast, color, frequency, timing, intensity, size, shape, and a combination thereof, and where the method further may include: determining whether the driver made a driving adjustment or whether the driving adjustment was sufficient, in response to the alert; and adjusting the parameter of the alert to improve responsiveness of the driver in making another driving adjustment in response to the parameter-adjusted alert. Method where the method further may include repeating the steps of obtaining and adapting to change a driving behavior of the driver. Implementations of the described techniques may include hardware, a method or process, or a computer tangible medium.

In one general aspect, vehicle control system may include a processor. Vehicle control system may also include a memory coupled to the processor to store instructions, which when executed by the processor, cause the processor to perform operations, the operations having: obtaining cognitive factor information corresponding to a driver of the vehicle; and adapting a driver interface of the vehicle based on the cognitive factor information; where the step of adapting may include alerting the driver via an alert using the adaptive driver interface. Other embodiments of this aspect include corresponding computer systems, apparatus, and computer programs recorded on one or more computer storage devices, each configured to perform the actions of the methods.

In one general aspect, method may include obtaining cognitive factor information corresponding to a driver of the autonomous vehicle. Method may also include adapting control of the vehicle based on the cognitive factor information. Method may furthermore include repeating the steps of obtaining and adapting to change a driving behavior of the driver. Other embodiments of this aspect include corresponding computer systems, apparatus, and computer programs recorded on one or more computer storage devices, each configured to perform the actions of the methods.

Implementations may include one or more of the following features. Method where the cognitive factor information may include inhibitive control information corresponding to the driver. Method where the inhibitive control information may include an assessed level of inhibitive control of the driver. Method where a manner of adapting control of the vehicle corresponds to the assessed level of inhibitive control of the driver. Method where obtaining cognitive factor information may include a cognitive factor information acquisition scheme selected from the group having of receiving driving data from monitoring driving behavior of the driver, completing a questionnaire for assessing driving behavior of the driver, and a combination thereof. Method where the driving behavior of the driver may include at least one driving behavior selected from the group having of: propensity to tailgate; reaction to a traffic light; propensity to change lanes; lane preference; frequency of lateral lane position shifting; propensity to speed in general; propensity to exceed a speed limit; propensity to pass vehicles; propensity to cut-off vehicles; propensity to speed around turns; propensity to be first to accelerate at a traffic light or sign; aggressive acceleration; aggressive deceleration; aggressive lane changing; aggressive following distance from vehicle ahead; and a combination thereof. Method where the control of the vehicle adapts from a first driving style that is in accordance with the driving behavior of the driver, to a second driving style that is not in accordance with the driving behavior of the driver, upon the repeating of the steps of obtaining and adapting. Method where the second driving style may include a safer driving style than the first driving style. Implementations of the described techniques may include hardware, a method or process, or a computer tangible medium.

In one general aspect, vehicle control system may include a processor. Vehicle control system may also include a memory coupled to the processor to store instructions, which when executed by the processor, cause the processor to perform operations, the operations having: obtaining cognitive factor information corresponding to a driver of the autonomous vehicle; adapting control of the vehicle based on the cognitive factor information; and repeating the steps of obtaining and adapting to change a driving behavior of the driver. Other embodiments of this aspect include corresponding computer systems, apparatus, and computer programs recorded on one or more computer storage devices, each configured to perform the actions of the methods.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 illustrates an example architecture for a vehicle control system for adapting a driver interface for a vehicle with which embodiments of the disclosed technology may be implemented.

FIG. 2 is a flowchart illustrating an example method for adapting a driver interface for a vehicle using driver cognitive factors, in accordance with embodiments disclosed herein.

FIG. 3 illustrates an example implementation of a system framework for adapting a driver interface for a vehicle, in accordance with embodiments disclosed herein.

FIG. 4A illustrates a virtual driving view or a real-world driving view of an example adaptive driver interface for a vehicle including an alert comprising transverse markings for alerting the driver when nearing a traffic light, in accordance with embodiments disclosed herein.

FIG. 4B illustrates a virtual driving view or a real-world driving view of an example adaptive driver interface for a vehicle including an alert comprising a circle for alerting the driver when nearing a traffic light, in accordance with embodiments disclosed herein.

FIG. 5 is a flowchart illustrating example operations for adapting a driver interface for a vehicle using driver cognitive factors, in accordance with embodiments disclosed herein.

FIG. 6 is a flowchart illustrating example operations for adapting control of an autonomous vehicle using driver cognitive factors, in accordance with embodiments disclosed herein.

FIG. 7 is an example computing component that may be used to implement various features of embodiments described in the present disclosure. The figures are not exhaustive and do not limit the present disclosure to the precise form disclosed.

### DETAILED DESCRIPTION

Embodiments of the systems and methods disclosed herein can provide adapting of a driver interface for a vehicle using cognitive factor information corresponding to a driver of the vehicle. In some examples, the systems and methods described in this disclosure can ascertain cognitive factor aspects/information about the driver (such as a driver's impulsivity or, conversely, a driver's inhibitory control) from which correlations can be applied to improve the driver's experience with the vehicle. This is done, for example, by adapting the driver interface (such as a human-machine interface (HMI)) based on the cognitive factor information in order to alert the driver, so as to increase awareness about their driving so that adjustments may be made by the driver in the operation of the vehicle. As will be apparent from this disclosure, basing the adapted adaptive driver interface on driver's cognitive factors ensures a safe and accident-free driving experience.

As many traffic accidents and violations happen daily due to poor impulsivity and inhibitory control, it is important to create driver safety systems that can overcome these cognitive limitations. Inhibitory tendencies/control refers to the ability of a person to control and inhibit impulsive automatic responses, which is in contrast to premeditative actions. This is one of the best factors that predicts risky driving behavior. This disclosure presents an example approach to decide when it is appropriate to enable or not enable a driver safety interface depending on a driver's inferred impulsivity and inhibitory control.

In an effort to create this approach, an example driving study was conducted by the inventors using a high-fidelity motion simulator to demonstrate how cognitive factors affect people's responses to driver safety interfaces. The study revealed that the interfaces had differing effects on drivers based on their impulsivity levels. In particular, it was observed that drivers with lower levels of impulsivity tended to slow down when exposed to the interfaces, while drivers with higher levels of impulsivity exhibited the opposite response. Indeed, research has shown that impulsive drivers are more likely to run yellow lights, even though yellow lights were designed to warn drivers that they may need to slow down. The study is the first to show that vehicle safety interfaces may also lead to unintended driving behavior responses for some drivers based on their impulsivity.

Leveraging the data collected in the study, the inventors have created a recurrent neural network that can infer cognitive traits and, based on these traits, decide whether or not to employ a driver safety interface. The results show that the decision-making scheme can infer latent cognitive factors that correlate with cognitive measures associated with impulsivity and inhibitory tendencies, and that can be used effectively to select driver interfaces and/or select parameters for driver safety interfaces to improve driver behavior, resulting in lower speed at the zone of dilemma of, for example, yellow lights. Although prior research has shown the relationship between cognitive factors such as impulsivity and driving behavior, this is the first time a model is proposed and examined so as to make driver safety recommendations based on cognitive factor inferences conditioned on the driver's behavior. Implementing such an adapted driver safety interface system could drastically increase the efficacy of driver safety interfaces, leading to safer driver behavior resulting in safer roads.

In terms of scalability, varying levels of the key cognitive factors (i.e., impulsivity and inhibitory control) could influence the effectiveness and acceptance of driver safety interfaces. This disclosure presents an approach for adapting driver interaction with adapted driver safety interfaces via learning a recurrent neural network-based model that infers cognitive factor traits from observable driving behavior in a scalable setting. In other words, this disclosure provides a system that, inter alia, implements a model that facilitates recognizing the inhibitory tendencies of a driver. These characteristics can be inferred from the driver's past behavior and can be used to make online decisions on whether or not to activate a driver safety interface (and optionally to what extent) such that risky driving behavior, such as speeding or running yellow lights, is reduced or eliminated for the driver.

Among the cognitive factors that influence risky driving behavior is impulsivity, which is the tendency to act without thinking, and inhibitory control, which is the ability to suppress goal-irrelevant stimuli and behavioral responses. Risky driving has been associated with higher self-reported impulsivity, and with poorer inhibitory control in relevant laboratory tasks. The significance of impulsivity as a risk factor for vehicle accidents has led to the idea of new intervention strategies. It is known that even a brief impulsivity intervention could help to prevent speeding. However, no study has focused on understanding how impulsivity affects the way drivers respond to driver safety interfaces, and how to adapt these interfaces based on a particular individual's impulsivity and inhibitory control.

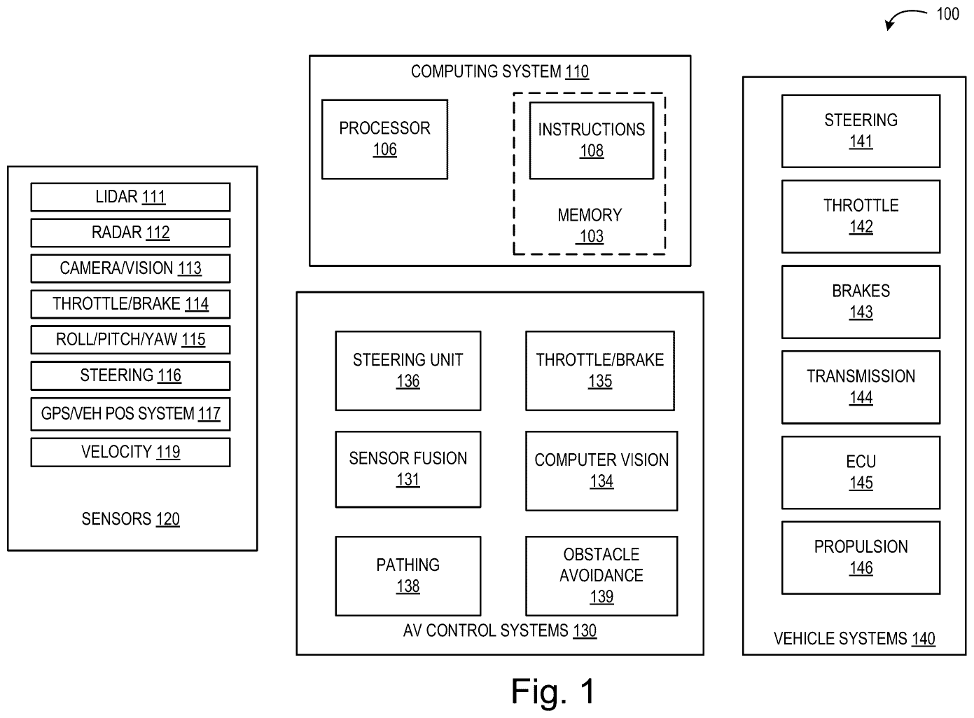

The systems and methods disclosed herein may be implemented with any of a number of different autonomous or non-autonomous vehicles and vehicle types. For example, the systems and methods disclosed herein may be used with cars, trucks, buses, construction vehicles and other on- and off-road vehicles. These can include vehicles for transportation of people/personnel, materials or other items. In addition, the technology disclosed herein may also extend to other vehicle types as well. An example autonomous vehicle in which embodiments of the disclosed technology may be implemented is illustrated in FIG. 1. This type of autonomous vehicle may be, for example, a Level 3 autonomous vehicle.

FIG. 1 illustrates an example autonomous vehicle with which embodiments of the disclosed technology may be implemented. In this example, vehicle 100 includes a computing system 110, sensors 120, AV control systems 130 and vehicle systems 140. Vehicle 100 may include a greater or fewer quantity of systems and subsystems and each could include multiple elements. Accordingly, one or more of the functions of the technology disclosed herein may be divided into additional functional or physical components, or combined into fewer functional or physical components. Additionally, although the systems and subsystems illustrated in FIG. 1 are shown as being partitioned in a particular way, the functions of vehicle 100 can be partitioned in other ways. For example, various vehicle systems and subsystems can be combined in different ways to share functionality.

Sensors 120 may include a plurality of different sensors to gather data regarding vehicle 100, its operator, its operation and its surrounding environment. In this example, sensors 120 include LIDAR 111, radar 112, or other distance measurement sensors, image (camera/vision) sensors 113, throttle and brake sensors 114, 3D accelerometers 115 (e.g., to detect roll/pitch/yaw or, alternatively, to detect just one vehicle orientation such as yaw), steering sensors 116, GPS or other vehicle positioning system 117, and a velocity sensor 119. Additional sensors can also be included as may be appropriate for a given implementation of AV control systems 130. For example, sensors 120 can include environmental sensors (e.g., to detect road/ground conditions such as ground wetness, ice, or other environmental conditions including, for example, atmospheric conditions such as weather). One or more of the sensors 120 may gather data and send that data to the vehicle electronic control unit (ECU) 145 or other processing unit. Sensors 120 (and other vehicle components) may be duplicated for redundancy.

Distance measuring sensors such as LIDAR 111, radar 112, IR sensors and other like sensors can be used to gather data to measure distances and closing rates to various external environmental conditions (such as ice patches) or objects such as other vehicles, obstacles (such as an other vehicle, traffic sign, pedestrian, animal, light pole, and pothole), and other objects. Image sensors 113 can include one or more cameras or other image/vision sensors to capture images of the environment around the vehicle. Information from image sensors 113 can be used to determine information about the environment surrounding the vehicle 100 including, for example, information regarding other objects surrounding vehicle 100. For example, image sensors 113 may be able to recognize landmarks or other features (including, e.g., street signs, traffic lights, etc.), slope of the road, lines on the road, curbs, objects/obstacles/environmental changes to be avoided (e.g., other vehicles, pedestrians, bicyclists, etc.) and other landmarks or features. Information from image sensors 113 can be used in conjunction with other information such as map data or information from positioning system 117 to determine, refine or verify vehicle location. Moreover, information from image sensors 113 can alternatively or additionally be used in conjunction with other information such as from the LIDAR 111 or radar sensors 112 to determine, refine or verify distances of any of the above items (e.g., obstacles/environmental changes) relative to the vehicle.

Throttle and brake sensors 114 can be used to gather data regarding throttle and brake application generated autonomously. Accelerometers 115 may include a 3D accelerometer to measure roll, pitch and yaw of the vehicle (or to measure just one vehicle orientation such as yaw, if desired). Accelerometers 115 may include any combination of accelerometers and gyroscopes for the vehicle or any of a number of systems or subsystems within the vehicle to sense position and orientation changes based on inertia.

Steering sensors 116 (e.g., such as a steering angle sensor) can be included to gather data regarding steering input for the vehicle generated autonomously (i.e., via the steering unit 136 (described below) when the vehicle is operated in autonomous driving mode). A steering sensor may include a position encoder to monitor the angle of the steering input in degrees. Analog sensors may be used to collect voltage differences that can be used to determine information about the angle and turn direction, while digital sensors may use an LED or other light source to detect the angle of the steering input. A steering sensor may also provide information on how rapidly the steering wheel is being turned. A steering wheel being turned quickly is generally normal during low-vehicle-speed operation, but is generally unusual at highway or other high speeds. Excessive steering input (e.g., turning a steering wheel quickly while the vehicle is traveling at such high speeds) can lead to vehicle control issues due to, for example, tire slippage from insufficiently low tire friction between the tire and road, in relation to the vehicle speed. In other words, if the steering unit 136 is turning the steering wheel at a fast rate while driving at highway or other high speeds, the vehicle computing system 110 may interpret that as an indication that the vehicle is out-of-control. Steering sensor 116 may also include a steering torque sensor to detect an amount of force the steering unit 136 is applying to the steering wheel.

Vehicle positioning system 117 (e.g., GPS or other positioning system) can be used to gather position information about a current location of the vehicle as well as other positioning or navigation information.

Vehicle velocity sensor 119 can be used to gather velocity information about a current speed of the vehicle. The vehicle velocity sensor 119 may also, for example, be embodied in GPS (or other positioning system) which can be used in calculating vehicle velocity by using multiple vehicle position information and timing information (i.e., the amount of time the vehicle takes to travel between vehicle positions). Alternatively, the vehicle velocity sensor 119 may be in the form of other non-wheel speed sensing techniques such as a transmission speed sensor which is a component mounted on a vehicle's transmission that lets the ECU 145 and/or computing system 110 know the current speed of the vehicle.

As commonly known, haptics use tactile interfaces (for example, steering wheels and seats) to provide touch or force feedback as part of the user interface (UI) in vehicles. For example, a vibrating seat may be used to inform the driver of a pedestrian crossing the street, when the vehicle approaches a yellow light, or when the vehicle is speeding.

The above haptic inputs from the driver can be easily measured by existing tactile sensing technologies currently provided on mass-produced vehicles. As an example, haptic feedback within a steering wheel can sense the force/pressure from the driver's hands and can provide a tactile alert to the driver. This feature can be used as an alternative to visual and auditory alerts or in conjunction with them. Haptic feedback is often used as part of the lane departure warning (LDW)/lane keep assist (LKA) systems. In these LDW/LKA systems, the steering wheel will vibrate if, for example, the vehicle senses it is veering out of the lane. These systems typically include one or more haptic feedback motors and a control module which is in communication with the haptic feedback motors. The control module is used to, inter alia, activate the motors to cause the steering wheel to vibrate when, for example, the vehicle senses it is veering out of the lane.

Although not illustrated, other sensors 120 may be provided as well. Various sensors 120 may be used to provide input to computing system 110 and other systems of vehicle 100 so that the systems have information useful to operate in an autonomous mode.

AV control systems 130 may include a plurality of different systems/subsystems to control operation of vehicle 100. In this example, AV control systems 130 include steering unit 136, throttle and brake control unit 135, sensor fusion module 131, computer vision module 134, pathing module 138, and obstacle avoidance module 139.

Sensor fusion module 131 can be included to evaluate data from a plurality of sensors, including sensors 120. Sensor fusion module 131 may use computing system 110 or its own computing system to execute algorithms to assess or otherwise use inputs from the various sensors.

Throttle and brake control unit 135 can be used to control actuation of throttle and braking mechanisms of the vehicle to accelerate, slow down, stop or otherwise adjust the speed of the vehicle. For example, the throttle unit can control the operating speed of the engine or motor used to provide motive power for the vehicle. Likewise, the brake unit can be used to actuate brakes (e.g., disk, drum, etc.) or engage regenerative braking (e.g., such as in a hybrid or electric vehicle) to slow or stop the vehicle.

Steering unit 136 may include any of a number of different mechanisms to control or alter the heading of the vehicle. For example, steering unit 136 may include the appropriate control mechanisms to adjust the orientation of the front and/or rear wheels of the vehicle to accomplish changes in direction of the vehicle during operation. Electronic, hydraulic, mechanical or other steering mechanisms may be controlled by steering unit 136.

Computer vision module 134 may be included to process image data (e.g., image data captured from image sensors 113, or other image data) to evaluate the environment surrounding the vehicle. For example, algorithms operating as part of computer vision module 134 can evaluate still or moving images to determine features and landmarks (e.g., road signs, traffic lights, lane markings and other road boundaries, etc.), obstacles (e.g., animals, pedestrians, bicyclists, other vehicles, other obstructions in the path of the subject vehicle) and other objects. The system can include video tracking and other algorithms to recognize objects such as the foregoing, estimate their speed and/or direction, map the surroundings, and so on.

Pathing module 138 may be included to compute a desired path for vehicle 100 based on input from various sensors 120 and AV control systems 130. For example, pathing module 138 can use information from positioning system 117, sensor fusion module 131, computer vision module 134, obstacle avoidance module 139 (described below) and other systems to determine a safe path to navigate the vehicle along a segment of a desired route. Pathing module 138 may also be configured to dynamically update the vehicle path as real-time information is received from sensors 120 and other AV control systems 130. This real-time information may be used as input for a computation of an optimal sequence/solution for the vehicle.

Obstacle avoidance module 139 can be included to determine control inputs necessary (i.e., input to vehicle systems 140) for controlling the vehicle's movement in order to avoid obstacles detected by sensors 120 or AV control systems 130. Obstacle avoidance module 139 can work in conjunction with pathing module 138 to determine an appropriate path to avoid a detected obstacle.

Vehicle systems 140 may include a plurality of different systems/subsystems to control operation of vehicle 100. In this example, vehicle systems 140 include steering system 141, throttle system 142, brakes 143, transmission 144, ECU 145 and propulsion system 146. These vehicle systems 140 may be controlled by AV control systems 130 in autonomous mode. For example, in autonomous mode, AV control systems 130, alone or in conjunction with other systems, can control vehicle systems 140 to operate the vehicle in a fully autonomous fashion.

Computing system 110 in the illustrated example includes a processor 106, and memory 103. Some or all of the functions of vehicle 100 may be controlled by computing system 110. Processor 106 can include one or more GPUs, CPUs, microprocessors or any other suitable processing system. Processor 106 may include one or more single core or multicore processors. Processor 106 executes instructions 108 stored in a non-transitory computer readable medium, such as memory 103.

Memory 103 may contain instructions (e.g., program logic) executable by processor 106 to execute various functions of vehicle 100, including those of vehicle systems and subsystems. Memory 103 may contain additional instructions as well, including instructions to transmit data to, receive data from, interact with, and/or control one or more of the sensors 120, AV control systems, 130 and vehicle systems 140. In addition to the instructions, memory 103 may store data and other information used by the vehicle and its systems and subsystems for operation, including operation of vehicle 100 in autonomous mode.

Although one computing system 110 is illustrated in FIG. 1, in various embodiments multiple computing systems 110 can be included. Additionally, one or more systems and subsystems of vehicle 100 can include its own dedicated or shared computing system 110, or a variant thereof. Accordingly, although computing system 110 is illustrated as a discrete computing system, this is for ease of illustration only, and computing system 110 can be distributed among various vehicle systems or components. In some examples, computing functions for various embodiments disclosed herein may be performed entirely on computing system 110, distributed among two or more computing systems 110 of vehicle 100, performed on a cloud-based platform, performed on an edge-based platform, or performed on a combination of the foregoing.

Vehicle 100 may also include a wireless communication system (not illustrated) to communicate with other vehicles, infrastructure elements, cloud components and other external entities using any of a number of communication protocols including, for example, V2V, V2I and V2X protocols. Such a wireless communication system may allow vehicle 100 to receive information from other objects including, for example, map data, data regarding obstacles, data regarding infrastructure elements, data regarding operation and intention of surrounding vehicles, and so on.

The example of FIG. 1 is provided for illustration purposes only as one example of a vehicle system with which embodiments of the disclosed technology may be implemented. One of ordinary skill in the art reading this description will understand how the disclosed embodiments can be implemented with this and other vehicle platforms.

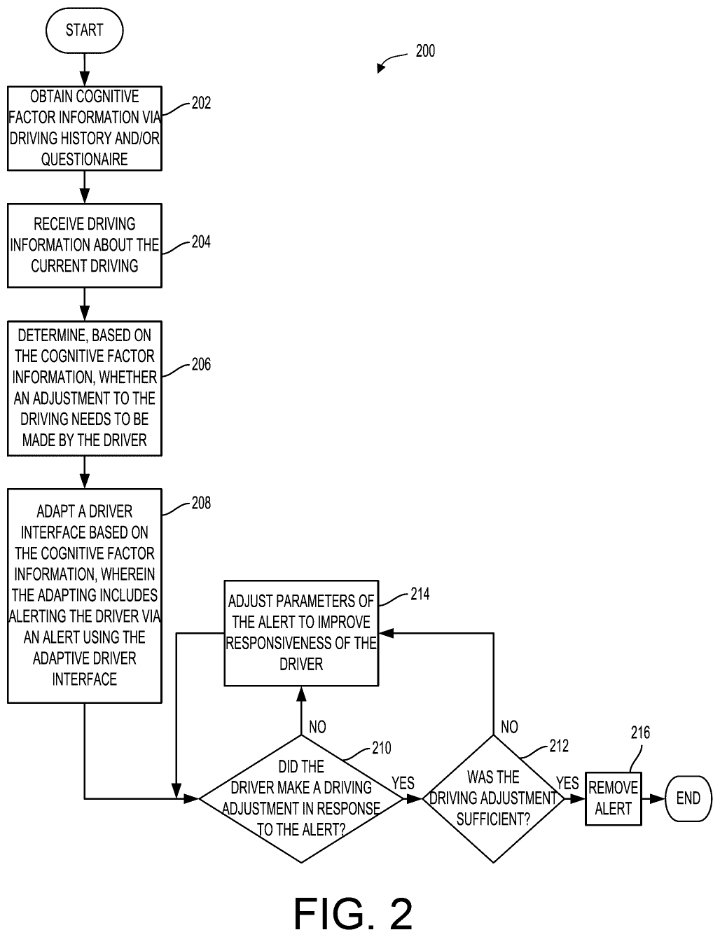

FIG. 2 is a flowchart illustrating an example method for adapting a driver interface for a vehicle using driver cognitive factors, according to aspects of the disclosure. A method 200 begins at block 202, in which cognitive factor information is obtained through one or more sources such as, for example, driving history, driver simulation data, a driver questionnaire and psychological tests. To obtain the driver's driving history, a determination may also be made (e.g., at block 202) as to the identification of the particular driver so that driver's driving history (actual or simulation-based) or corresponding information to be pulled from a database or other storage device such as, for example, memory 103 for the vehicle 100 of FIG. 1 or memory at a server.

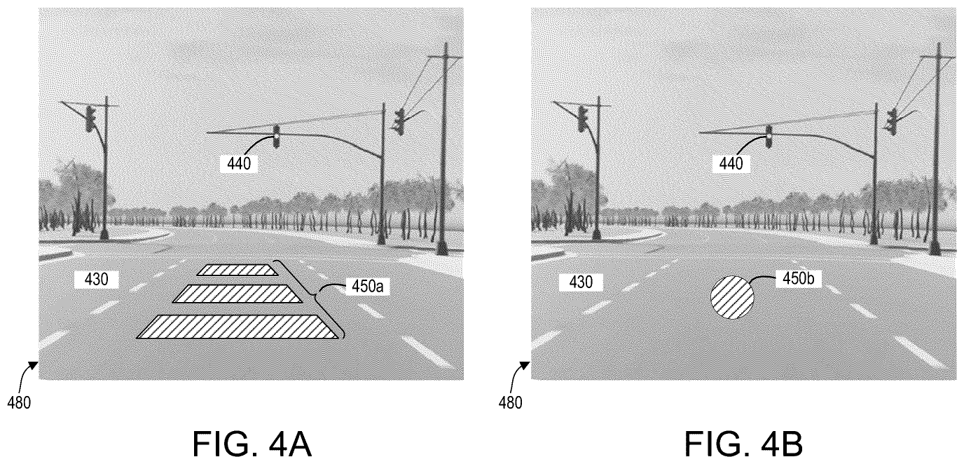

At block 204, driving information about the manner in which the vehicle is currently being driven is received (e.g., whether the vehicle is approaching a yellow traffic light 440 such as shown in FIGS. 4A and 4B). Driving environment information may be obtained, for example, using LiDAR 111, radar 112 or other sensor or infrastructure data. Vehicle information can be obtained by various vehicle sensors or external sensors in the vicinity monitoring the vehicle. This can determine, for example, vehicle speed, acceleration or deceleration, throttle position, vehicle braking, roll/pitch/yaw, or other information.

At block 206, a determination is made based on the cognitive factor information as to whether an adjustment to the driver's current driving behavior or style needs to be made by the driver, such as for safety, efficiency or other reasons. For example, in the yellow traffic light 440 example above, adjustments might be made to decrease or increase vehicle speed based on factors such as timing of the yellow traffic light 440, current vehicle speed, distance to the light, whether there are other vehicles in the vehicle's path, etc. The timing of the yellow traffic light 440 may be based on, for example, the elapsed time calculated from the start of the yellow mode of the traffic light or the remaining time of the yellow mode of the traffic light, if known and obtainable from information stored or accessible from the cloud or other sources. As another example, where the vehicle is approaching a curve in the road, actions might be taken to adjust the vehicle speed based on factors such as current vehicle speed, sharpness of the curve, other traffic in the vicinity, weather conditions, road conditions, road surface type and so on.

At block 208, a driver interface is adapted based on the cognitive factor information, wherein the adapting may include alerting the driver via an alert 450a, 450b using the adaptive driver interface (e.g., windshield heads-up display 480, head-unit display screen, instrument-binnacle display screen, or other interface). In the examples shown in FIGS. 4A and 4B, the driving adjustment can be to reduce or increase speed in response to the vehicle approaching the yellow traffic light 440 or a bend in the road as per the above two examples. For example, the driving behavior information might yield that the driver tends to wait too long to apply the brakes when approaching a yellow traffic light and is predicted to run a red traffic light. This prediction might be based on information such as the current vehicle speed and remain timing of the yellow mode of the traffic light. In this case, the alert may activate sooner and with sufficient time for the driver to make a driving adjustment (e.g., start braking) in order to make the vehicle come to a stop prior to the vehicle passing what will soon be a red traffic light.

At block 210, a determination is made as to whether the driver made an actual driving adjustment in response to the alert. This determination may be accomplished, for example, by determining whether a change was made in vehicle control parameters such as steering, braking, throttle, pitch etc, and if so, the magnitude of the change. This change in one or more vehicle control parameters may be determined via monitoring or evaluating data from various sensors such as throttle/brake sensor 114, steering sensor 116, velocity sensor 119, roll/pitch yaw sensor 115, etc., shown in FIG. 1.

If the driving adjustment was determined to be made, then the method proceeds to block 212 where a determination is made as to whether the driving adjustment was sufficient. If the driving adjustment was determined per block 210 to not be made, then the method proceeds to block 214 where parameters of the alert are adjusted to improve responsiveness of the driver. Such adjustments may be made repeatedly, and may be made with escalation, until the driver makes a driving adjustment in response to the alert. If the driving adjustment is determined to be sufficient per block 212 (i.e., meaning that the alert was successful in directing the driver to make a sufficient driving adjustment), then the method proceeds to block 216 where the alert is removed. For example, the alert 450a, 450b is no longer projected and therefore is removed from the windshield heads-up display 480. The alert may also time out, or it may be removed once the circumstance giving rise to the alert is passed (e.g., the vehicle passed through the intersection).

In block 212, the sufficiency of the driving adjustment may be determined via, for example, a comparison of the amounts of vehicle control parameters (such as steering, braking, throttle input, etc. as measured via monitoring of the various sensors such as throttle/brake sensor 114, steering sensor 116, velocity sensor 119, etc. shown in FIG. 1) with predetermined threshold values or historical data values. If the driving adjustment is determined per block 212 to not be sufficient, blocks 214 and 210 are repeated (with repeated adjustments made to parameters of the alert, per block 214) until the driving adjustment is determined to be sufficient or until the situation is over. For example, the alert 450a, 450b is adjustable via an alert parameter such as brightness, contrast, color, frequency, timing, intensity, volume, size, and/or shape.

Method 200 may provide for learning which driving adjustments were sufficient (e.g., the driver reduced speed when approaching a yellow traffic light and successfully avoided running a red light). This determination could be part of the determination in block 212. Block 212 may alternatively learn which driving adjustments were not sufficient (e.g., the driver did not reduce speed or did not reduce speed sufficiently when approaching a yellow traffic light and ran a red light). The information as to whether or not the driving adjustments were sufficient may be used to adjust the parameters of the alert to improve responsiveness of the driver, per block 214. In other words, the information can be used to adjust future alerts to the driver. In some applications, the alerts may be tailored in a manner specific to the driver such as by learning a driver's responsiveness to various alerts. For example, the system may determine that a particular driver responds better to audible alerts than that driver responds to visual alerts, or the driver may respond better to visual alerts of a particular color or add a particular frequency. As another example, the system may determine that hey particular driver may respond better to a stern warning than a gentle reminder.

Thus, method 200 is not only capable of making real-time determinations in terms of providing real-time alerts, but may also learn based on a driver's driving history, cognitive factor information (e.g., inferred through data depicting actual behavior or filled out via a mobile app or other questionnaire), and alert responsiveness, as well as effectiveness of the driver's prior driving adjustments and responsiveness to prior alerts. In some applications, some or all of this information may be gathered based on information from driver questionnaires, psychological tests, simulation data and actual driver history.

While each of the steps of FIG. 2 may be performed in real time, some steps may be performed before or after the fact. For example, in various operations, the step of block 202 may be performed in advance of any driving maneuvers so that the information is on hand and available for analysis and action. The operations of blocks 210-214 may also be performed in non-real-time. For example, the analysis of the operations at blocks 210, 212 and the adjustment at block 214 may be performed at a later time with the data being analyzed and evaluated after the fact and alert adjustments being made after the fact as well. This may allow certain implementations to adjust alerts based on a number of different driving situations and maneuvers. In other applications, the analysis and adjustment may also be performed in real time to, for example, improve the alert while the current situation is still occurring.

### Contrastive Learning of Personal Traits

In the experiment described below, a neural network-based model was used for encoding a driver's latent cognitive factors. More particularly, the model was trained to encode the latent cognitive factors in order to distill the recent driving history down to a low-dimensional parameter space whose structure is malleable. The structure of the space can also be easily shaped via multiple cognitive measures. The model may include a context encoder whose input is a trajectory of driving behavior in a scenario and outputs a low-dimensional latent vector which is representative of the low-dimensional parameter space. The low-dimensional latent vector may be coupled with a decision-making module that takes in this latent vector and outputs a decision. After experimenting with the size of the latent vector, the inventors found that a two-dimensional latent vector was sufficient to capture cognitive factors, retain interpretability of the low-dimensional parameter space, and be used with additional two-dimensional latent vectors for reshaping of the structure of the low-dimensional parameter space in that particular experiment. This particular model approach described herein in terms of the experiment below may also be employed in a real-world driving scenario. In various applications, the model may accept as input, prior knowledge of the driver based on information such as driving history questionnaires and collected driving data and may also accept as input the current state of the environment at the current location. The model determine whether an intervention should be made and, if so, which form of intervention may be most effective given the data inputs. The model may then output these determinations. When applied to real world data as compared to in an experimental environment, the model may be augmented to account for noise inherent in real world sensors and situations.

The context encoder is a neural network, q_{ψ}(z|τ), defining the probability of latent vector z given a past trajectory τ of the driver. q_{ψ}(z|τ) is represented as a long short-term memory (LSTM) network, taking in a trajectory history. The hidden layer h is fed into two linear layers that output the mean and log-variance of the latent encoding.

As driving actions offer a noisy and ambiguous observation of the psychological traits, contrastive learning may also be used in a real-world driving scenario based on the cognitive measures described in this Experiment section (in this example, goRT_all, UPPS-P Positive Urgency, DBQ-Ordinary Violations, and BAS_sensation). A suitable approach is used with only a partial set of cognitive measures as a full set for all subjects would be impractical in the fleet-level case envisioned, to shape the resulting latent space according to variables of interest.

The context encoding model encodes a latent vector z conditioned on the driver's past driving history t and uses a decoder network p(a|z) to estimate the action at the timestep immediately after T. The overall loss (L₁, L₂, L₃) used to train the encoder consists of three components:

L₁(aₜ₊₁, p, z)=E_{z} log p(a/z), which represents the log-likelihood of future action estimate aₜ₊₁ at timestep t+1 predicting the true action âₜ₊₁ induced by the conditional distribution p over z, where z characterizes driving behavior up to time t.

L₂ (z, y), which represents a contrastive loss supervised using the cognitive factors. For continuous-valued cognitive measures, this loss is

$$( 1 )$$

$${L}_{2} ( z , y ) = {\sum }_{( {z}_{0} , {z}_{1} ) ∈ ℨ \times ℨ} ( 1 - {‖ {y}_{{z}_{0}} - {y}_{{z}_{1}} ‖}^{2} ) {ℓ ( {z}_{0} , {z}_{1} )}^{2} + {‖ {y}_{{z}_{0}} - {y}_{{z}_{1}} ‖}^{2} {max ( 0 , ϵ - ℓ ( {z}_{0} , {z}_{1} ) )}^{2} ,$$

where Z represents a training samples batch, where each zi∈Z is a |Z|-dimensional latent vector induced by the LSTM context encoder, y_{z}_{ᵢ} is a vector of batch-normalized cognitive measures associated with zi, [symbol] (z0, z1) is a measure associated with two vectors z0 and z1 (which are chosen as their Euclidean distance, i.e. ∥z0-z1∥), and e is a margin controlling distance of dissimilar y-values in z-space. Here, notation is not considered and zi is associated with the population sample it belongs to.

L3 (z)=DKL(z|N (0, l)), which represents a Kullback-Leibler (KL)-regularization loss for the distribution of z. N (0, l) is the unit-normal distribution of appropriate dimension.

These terms are combined into an overall training loss:

$$L ( {a}_{t + 1} , p , z , y ) = {α}_{1} {L}_{1} ( {a}_{t + 1} , p , z ) + {α}_{2} {L}_{2} ( z , y ) + {α}_{3} {L}_{3} ( z ) , \qquad ( 2 )$$

where p is distribution modeled by the decoder network.

The utility of the inferred latent factors model is probed by marrying it with a decision rule for selecting the activation of the human-machine interface (HMI). The decisions are defined via a simple classifier based on the latent factors. The classifier is set to optimize a criterion for HMI selection within the training data. The criteria considered includes the difference in the speed when approaching the yellow light with and without HMI, formulated as a classification. This criterion reflects the speed reduction induced in the subject when an HMI is shown. Support Vector Regression is used with a polynomial kernel as our decision model.

### Experiment

Drivers were recruited and asked to execute multiple driving trials (laps) on a closed-loop road section in a high-fidelity full-scale vehicle motion simulator. Participants drove on a road with traffic lights that randomly changed from green to yellow at varying times of arrival of the vehicle at the traffic light, inducing a zone of dilemma. Four driving trials (laps) were collected where participants interacted with different prototype driver safety interfaces and one baseline driving trial, without the interfaces, that was used for latent cognitive factor inference via a learned neural network model.

Leave-one-out cross-validation was used among participants to estimate the model's inference on the population, for both latent cognitive factor estimation and the resulting decision classifier based on the latent cognitive factors. In order to evaluate the interface selection decisions by the decision classifier, they were compared to a globally optimal decision rule that used the same interface for all participants. The participants' behavior was measured in terms of behavior statistic (mean average yellow light traveling speed) for the selected HMI choice over the withheld subject as a within-participants randomized trial of the efficacy of the HMI selection mechanism.

### Driver Safety Interfaces

Two types of example warning adaptive driver interfaces were used in the experiment described herein. Although FIGS. 4A and 4B are described herein in terms of illustrating example warning adaptive driver interfaces implemented in examples of the disclosed technology in real-world, non-experimental driving scenarios (i.e., using a windshield heads-up display 480), FIGS. 4A and 4B may also represent virtual driving views on a display (e.g., computer monitor) of the example warning adaptive driver interfaces used in the experiment conducted as described herein. When viewing FIGS. 4A and 4B in terms of the virtual driving views scenario used in the experiment, the figures show: a) transverse markings (such as alert 450a shown in FIG. 4A), projected on the road the car was driving; and b) a 2D yellow circle (such as alert 450b shown in FIG. 4B), projected as if it appeared in a heads-up display. As mentioned, FIGS. 4A and 4B may show the virtual scenarios and both adaptive driver interface types. In the experiment, for each adaptive driver interface, the trigger condition was also manipulated to display it. For example, each adaptive driver interface was either displayed when the vehicle approached the traffic light (e.g., 185 meters away-regardless of that state of the traffic light) or, alternatively, when the upcoming traffic light changed from green to yellow.

### Participants

Thirty-nine drivers 18-years-old and older (Mean age=49, Female=16, Non-binary=1) participated in the experiment. Of these 39 participants, seven participants did not complete the driving trials due to motion sickness. Of the 32 remaining participants, the data of 5 participants was excluded from the analysis due to technical or operational issues.

### Measures

Impulsivity: To assess participants' impulsivity, the commonly known BIS/BAS scale and the commonly known UPPS-P scale were used. The BIS/BAS scale was used to measure both the behavioral inhibition system (BIS) and the behavioral activation system (BAS), while the UPPS-P was used to account for the different facets of impulsivity.

Inhibitory Control: the commonly known Go-No Go task and the commonly known Stop Signal task were used to measure response inhibition of the driver.

Self-reported Driving Behavior: To assess participants' road errors and violations, the commonly known Manchester Driver Behavior Questionnaire (DBQ) was used.

Driving Behavior in the Motion Simulator: driving behavior was also captured/measured as participants drove in the motion simulator. The participants' driving speed, acceleration and response to yellow traffic lights were recorded in an effort to assess their driving behavior.

### Results

The relationship between various aspects of impulsivity, inhibitory control, driving behavior, and responses to HMIs designed to encourage drivers to slow down were analyzed. The performance of our model in inferring participants' cognitive factors and in predicting if they should interact with our HMIs was then analyzed.

Relationship between Cognitive Factors and Driving Behavior.

To understand the relationship between the different cognitive factors and driving behavior when reacting to the yellow lights, a Bayesian correlation analysis was conducted using JASP software. For the analysis, the data of all driving laps was used. A number of significant correlations emerged.

The self-reported ordinary violations measure on the DBQ was positively correlated with the mean speed at the yellow light (r=0.4, BF10=9693) and the maximum speed at the yellow light (r=0.54 BF10=1.141×10⁺⁹), indicating that drivers who reported higher levels of ordinary violations were more likely to speed through yellow lights.

Several correlations were found between the BIS/BAS measures and driving behavior. In particular, BAS “Sensation Seeking” factor was positively correlated with the mean speed at the yellow light (r=0.473, BF10=1.700×10⁺⁶) and the maximum speed at the yellow light (r=0.31, BF10=99.19). This suggests that individuals who have a higher desire for new and exciting experiences may be more likely to take risks while driving, such as speeding through yellow lights. BAS “Reward Responsiveness” factor was also positively correlated with the maximum speed at the yellow light (r=0.29, BF10=39.63).

Similar to the BIS/BAS measures, various correlations emerged using the UPPS-P subscales. For instance, UPPS-P “Positive Urgency” factor was positively correlated with the maximum speed at the yellow light (r=0.28, BF10=26.93), and UPPS-P “sensation seeking” factor was positively correlated with the mean speed at the yellow light (r=0.29, BF10=42.89) and the maximum speed at the yellow light (r=0.47, BF10=1.540×10⁺⁶). These results are consistent with the results found for BAS “Sensation Seeking” and BAS “Reward Responsiveness” factors, which provides further evidence that people who desire enhanced sensation and new and thrilling experiences are more likely to speed and take risks when reacting to traffic lights.

Multiple correlations also emerged using the measures from the Stop Signal task. For instance, the reaction time on go trials with a response (goRT_all) was negatively correlated with the mean speed at the yellow light (r=−0.38, BF10=2933). This suggests that drivers with faster reaction times may be more likely to slow down at yellow lights rather than speeding through them.

Finally, numerous correlations were found using the Go/No-Go measures. Among the correlations, the average response time (gonogo_average_rt) was negatively correlated with the mean speed at the yellow light (r=−0.46, BF10=352747) and the maximum speed at the yellow light (r=−0.40, BF10=9205), which is consistent with the reaction time results from the Stop Signal task (e.g. goRT_all).

### Impact of the Cognitive Factors on People's Responses to the Interfaces

To understand how different factors affect the way drivers respond to HMI, a linear mixed models (LMM) analysis was conducted on the experimental example herein by the inventors. Multiple LMMs were fitted to understand the effects of the different factors, the presence or not of an HMI (HMI_presence) and the possible interactions. Participant ID was used as a random effect to account for individual differences among participants. The Imer function in the Ime4 R package was used to predict the mean speed at yellow light based on different variables, as illustrated below:

$$Mean\_speed \_yellow ∼ HMI\_presence * GoRT\_all + ( 1 \vert Participant ) , \qquad ( 3 )$$

The models were fitted using the Restricted Maximum Likelihood (REML) estimation method and the t-tests were computed using the Satterthwaite's approximation method.

### BIS/BAS

Using HMI presence and the BIS/BAS measures as independent variables, main and interaction effects were found using the measures BAS “Reward Responsiveness” (BAS_reward) and BAS “Sensation Seeking” (BAS_Sensation). Using BAS_reward, there was a main effect of the HMI_presence (β=−0.03, SE=14.39, t=−3.15, p=0.002), and a significant interaction between HMI_presence and BAS_reward (β=1.48, SE=0.47, t=3.095, p=0.002). Using BAS_Sensation, there was a main effect of the HMI_presence (B=−11.14, SE=4.64, t=−2.4, p=0.01), and a significant interaction effect between HMI_presence and BAS_Sensation (β=0.9, SE=0.39, t=2.31, p=0.02). Participants with higher BAS “Sensation Seeking” were more likely to have a higher mean speed at the yellow light when the HMI was present, while participants with lower BAS “Sensation Seeking” were more likely to have a lower mean speed at the yellow light with the HMI present.

### UPPS-P

Using the UPPS-P subscales, there was a significant main effect of the “Positive Urgency” subscale on the mean speed at the yellow light (β=−8.71, SE=2.65, t=−3.28, p=0.001), and a significant interaction effect between “Positive Urgency” and HMI_presence (β=1.23, SE=0.38, t=3.22, p=0.002). Specifically, in the HMI_presence condition, higher levels of positive urgency were associated with higher mean speed at the yellow light, as shown in FIG. 4. Similarly, when using the “Sensation Seeking” subscale, there was a significant main effect of HMI_presence (β=−7.6, SE=3.06, t=−2.48, p=0.01) and a significant interaction effect between sensation seeking and HMI_presence (β=0.64, SE=0.26, t=2.38, p=0.01).

### Go/No-Go Measures

In the analysis of the Go/No-Go measures, there was a statistically significant and negative effect of the average response time (gonogo_average_rt) (β=−0.07, SE=0.027, t=−2.56, p=0.01). There were no other main or interaction effects.

### Stop Signal Measures

Using the Stop Signal measures, there was a main effect of goRT_all (B=−0.02, SE=0.008, t=−2.68, p=0.01), usRT (β=−0.02, SE=0.01, t=−2.36, p=0.02), and SSD (β=−0.02, SE=0.007, t=−2.67, p=0.01). Also, there was a significant interaction effect between HMI_presence and Stop Signal Reaction Time (SSRT) (β=−0.01, SE=0.007, t=−2.00, p=0.04). People with higher SSRT were more likely to have a lower mean speed at the yellow light when exposed to the HMI, while people with lower SSRT were more likely to have a higher mean speed at the yellow light.

### Manchester DBQ

Finally, given the relationship of impulsivity and driving violations, separate linear mixed models were fitted using each Manchester DBQ measure and HMI_presence as independent variables. Using the “Ordinary Violations” subscale (dbq_ordinaryViolations), there was a main effect of HMI_presence (β=−6.99, SE=2.75, t=−2.53, p=0.01) and a significant and positive interaction effect between HMI_presence and dbq_ordinaryViolations (β=0.47, SE=0.19, t=2.44, p=0.01). Participants with a higher number of self-reported ordinary driving violations were more likely to have a higher mean speed at the yellow light when the HMI was present, while participants with a lower number of self-reported driving violations were more likely to have a lower mean speed at yellow light with the HMI present. Using the “Errors” subscale (dbq_errors), there was also a significant main effect of HMI_presence (B=−12.71, SE=6.03, t=−2.1, p=0.03), and a significant interaction effect between the HMI_presence and dbq_errors (β=0.95, SE=0.46, t=2.03, p=0.04).

Inferring Inhibitory Control and HMI Choice from Driving Behavior

Given the various measures collected in the study, stepwise regression was used to select the most important features for the model. Forward selection, starting with an empty model and adding the predictor that produced the largest increase in model fit were combined, with backward elimination, removing the predictor that produced the smallest decrease in model fit until no further improvement was observed. By following this process, the following variables were selected to use in the model: UPPS-P-Positive Urgency, BAS Sensation Seeking, goRT_all, and DBQ-Ordinary violations.

The approach described above was used to infer cognitive factors based on the subjects' driving during the experiment. Leave-one-out was also used over 27 subjects, averaging model performance over 6 random seeds, to capture properties of the embedding and the resulting training decision criteria performance.

Table 2 shows the fit between the distribution of the selected cognitive and the inferred latent cognitive factors. Since there is no direct or linear mapping assumed in contrastive learning, the uniformity of the inferred embedding was probed. The KL distance is used between the cognitive measures and the inferred factors' distribution. Specifically, the approach normalizes over an ideal clustering result with two normal distributions separated by a unit-distance (the regularization term L₃). Note BAS Sensation is significantly higher, indicating stronger separation.

When leveraging the latent cognitive factors to decide on an HMI choice, a balanced accuracy of 56% and a Cohen Kappa of 0.145 was achieved in selecting the optimal HMI for the specific driver, as shown in Table 1 below, resulting in a reduction of 0.59 m/s in the mean speed at yellow traffic light crossing. More specifically, as can be seen in Table 1, the inferred latent cognitive factors enable adapted HMI selection with 56% balanced accuracy compared to 50% and 0.145 Cohen Kappa (vs 0.001) compared with a balanced-random HMI choice, resulting in 0.59 m/s decrease in yellow light driving speed.

TABLE 1
Resulting accuracy of interface selection based on the inferred
latent cognitive factors using test datasets obtained by performing
leave-one-out cross-validation on the full set of test subjects

| | Mean Yellow | | | |
|---|---|---|---|---|
| | Light Speed (m/s) | | Cohen's | |
| | | Standard | Kappa | Balanced |
| Decision Rule | μ | Error | Score | Accuracy |
| No-HMI | 17.36 | 1.12 | 0.0 | 0.50 |
| Always-HMI | 15.48 | 1.10 | 0.0 | 0.50 |
| Random | 15.69 | 1.14 | 0.001 | 0.50 |
| Window-Averaged | 15.10 | 1.09 | 0.145 | 0.56 |
| (present disclosure) | | | | |
| Instantaneous | 15.50 | 1.10 | 0.024 | 0.51 |
| (present disclosure) | | | | |

TABLE 2
Normalized KL Divergences of the subjects for the
cognitive measures used in the contrastive loss,
averaged over 10 folds (higher is better)

| | UPPS-P Positive | DBQ Ordinary | BAS Sensation |
|---|---|---|---|
| goRT all | Urgency | Violations | Seeking |
| 0.322 | 0.299 | 0.288 | 0.526 |

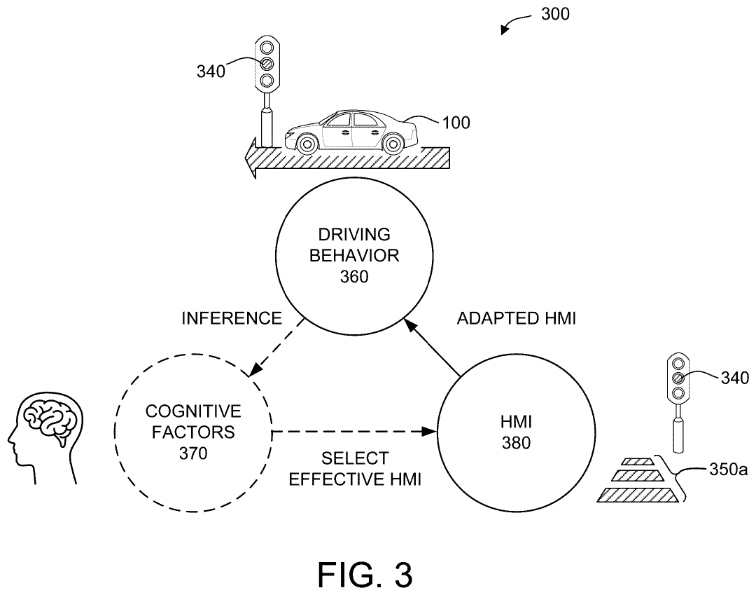

FIG. 3 illustrates an example conceptual implementation overview of a system framework 300 for adapting a driver interface (HMI 380 which may be, for example, a windshield heads-up display 480 in FIG. 4A or other HMI, during an example real-world driving scenario) for a vehicle 100, in accordance with embodiments disclosed herein. Latent cognitive factors 370 embed cognitive measures from the driving behavior 360 of a driver of the vehicle 100 and are used to inform an HMI selection (dashed lines). Solid lines represent the observable driving behavior of the driver and an adapted HMI. As described more fully above with respect to FIG. 3, and below with respect to FIGS. 4A, and 4B, the HMI 380 in FIG. 3 (e.g., windshield heads-up display 480 in FIG. 4A) displays an example alert 350a (e.g., alert 450a in FIG. 4A) when the vehicle 100 approaches a yellow traffic light 340 (e.g., yellow traffic light 440 in FIG. 4A).

In terms of illustrating example warning adaptive driver interfaces implemented in examples of the disclosed technology in real-world, non-experimental, driving scenarios, FIGS. 4A and 4B depict a situation in which the driver is alerted via an alert 450a, 450b when the vehicle approaches a yellow traffic light 440 via roadway 430. The alert 450a, 450b is active (e.g., displayed/projected on/onto the windshield heads-up display 480 of a vehicle via a heads-up display) to nudge the driver when a driving adjustment needs to be made by the driver. The alert 450a is shown in FIG. 4A as trapezoidal transverse/horizontal-oriented bars, whereas in FIG. 4B, the alert 450b is shown as a circle. Other types of visual alerts may alternatively be used. For example, alerts that have different shapes, sizes, number of parts/sections, etc. may be employed.

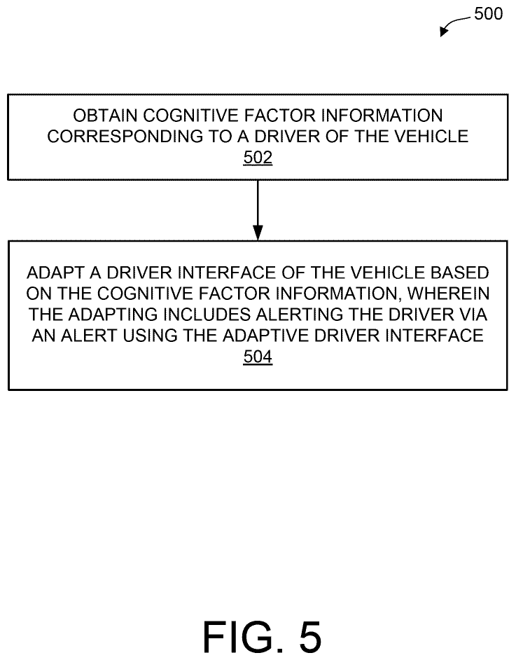

FIG. 5 is a flowchart illustrating example operations that can be performed for adapting a driver interface for a vehicle, in accordance with some embodiments disclosed herein. Inherent in this process is the ability to provide an alert to a driver of a vehicle via an adapted driving interface based on cognitive factor information corresponding to the driver. Example method 500 may be performed by the corresponding systems of the vehicle illustrated in FIG. 1.

At operation 502, cognitive factor information is obtained corresponding to a driver of the vehicle. The cognitive factor information may comprise inhibitive control information corresponding to the driver. As mentioned above, the cognitive factor information may be obtained via a cognitive factor information acquisition scheme. As on example, a cognitive factor information acquisition scheme may include receiving driving data from one or more sensors that monitor, driving behavior of the driver. This may include sensors from the driver's vehicle, sensors of vehicles proximate the driver or infrastructure sensors. As another example, the cognitive factor information acquisition scheme may include receiving driving data from a completed questionnaire that assesses driving behavior of the driver. A questionnaire may be completed by the driver or even another person via, for example, an HMI in the vehicle or via the driver's mobile device or other computing device.

The driving behavior of the driver obtained via an acquisition scheme may include, for example, one or more of the following driver behaviors: propensity to tailgate; reaction to a traffic light (e.g., propensity to increase or decrease speed when approaching a traffic light); propensity to change lanes; lane preference; frequency of lateral lane position shifting; propensity to speed; propensity to pass vehicles; propensity to cut-off vehicles; propensity to speed around turns; propensity to be first to accelerate at a traffic light or sign; aggressive acceleration; aggressive deceleration; aggressive lane changing; and aggressive following distance from vehicle ahead. The obtained driving behavior can be used to classify the driver's inhibitory control via the model mentioned above. In the method 500, the steps of obtaining and adapting may be repeated to change a driving behavior of the driver.

At operation 504, a driver interface of the vehicle is adapted, based on the cognitive factor information. The step of adapting comprises alerting the driver via an alert using the adaptive driver interface. As a specific example, the system may adapt the HMI through, for example, implementing changes that correspond to the level of inhibitory control of the driver. The feedback may be provided in a way that avoids annoying the driver.

In one aspect, the system may adapt or customize the alert via an alert parameter such as brightness, contrast, color, frequency, timing (e.g., making it occur earlier to give the driver time to recognize the alert and adapt), intensity, size, and/or shape, etc. to improve responsiveness of the driver to the HMI via the alerts. As one example, a driver that lacks inhibitory control and is more risk adverse, that driver may be less likely to pay attention to alerts from the vehicle. Thus, the system may be configured to adapt the alerts. For example, as noted above, the alerts may be adapted or customized to be more apparent to the driver to better get the driver's attention and driver increase the driver's awareness about their driving. As another example, the alerts may be adapted or customized to a way that is preferred by the driver and may avoid being an annoyance. As another example, the system may consider particular aspects related to regional differences, such as aspects of driving to which the driver should be more focused in a particular area versus an area in which they more commonly drive. Thus, when the driver transitions to an area with overall reduced speeds, the system may emphasize speed alerts according to the driver's inhibitory control, such as providing additional warnings to maintain a speed when a driver has low inhibitory control, or no alerts if a driver has high inhibitory control.

In some examples, the inhibitive control information comprises an assessed level of inhibitive control of the driver. In one example, and as mentioned above, the alert made in operation 504 above is adaptable via a parameter such as, for example, volume, brightness, contrast, color, frequency, timing, intensity, size, and/or shape, wherein the adaptability of the alert corresponds to the assessed level of inhibitive control of the driver.

In some examples, the alert made in operation 504 above comprises a type such as, for example, audio, visual, and/or haptic, provided by an HMI or other vehicle device. The alert made in operation 504 above may also or alternatively be presented by a user device such as a user's mobile device. The alert signals the driver to adjust control of the vehicle, depending on the circumstances. As per the example above, the driver is alerted via an alert 350a, 350b (FIGS. 3A, 3B) when the vehicle approaches a yellow traffic light 340. The alert 350a, 350b may be active (e.g., displayed/projected on/onto the windshield heads-up display 380 or other HMI) to nudge the driver when a driving adjustment needs to be made by the driver. In this example, the driving adjustment can be to reduce or increase speed in response to approaching the yellow traffic light. Other types of HMI's may employ alerts such as, for example, a dashboard, steering wheel, shifter, seat, speakers, etc.

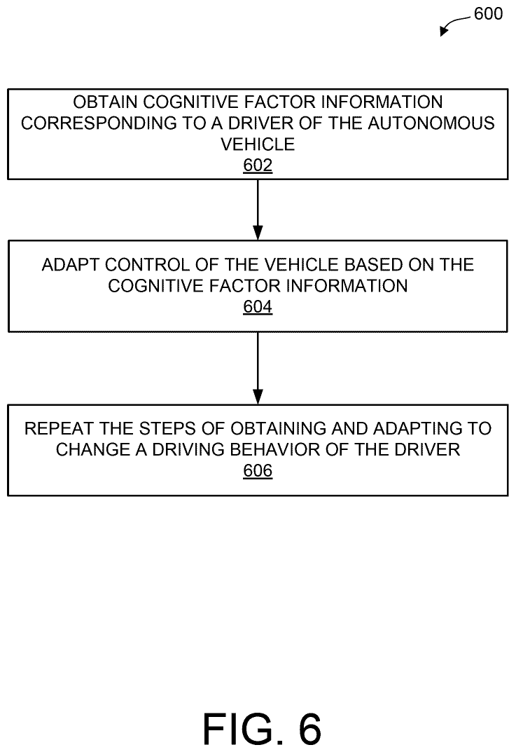

FIG. 6 is a flowchart illustrating example operations that can be performed for adapting control of an autonomous vehicle, in accordance with some embodiments disclosed herein. Inherent in this process is the ability to change a driving behavior of the driver of a vehicle via adaptively controlling the vehicle using cognitive factor information corresponding to the driver. Example method 600 may be performed by the corresponding systems of the vehicle illustrated in FIG. 1.

At operation 602, cognitive factor information is obtained corresponding to a driver of the autonomous vehicle. The cognitive factor information may comprise inhibitive control information corresponding to the driver. As mentioned above, the cognitive factor information may be obtained via a cognitive factor information acquisition scheme. The cognitive factor information acquisition scheme may include receiving driving data from monitoring driving behavior of the driver and/or from completing a questionnaire for assessing driving behavior of the driver. The driving behavior of the driver obtained via either acquisition scheme may include any one or more of the following driver behaviors: propensity to tailgate; reaction to a traffic light (e.g., propensity to increase or decrease speed when approaching a traffic light); propensity to change lanes; lane preference; frequency of lateral lane position shifting; propensity to speed; propensity to pass vehicles; propensity to cut-off vehicles; propensity to speed around turns; propensity to be first to accelerate at a traffic light or sign; aggressive acceleration; aggressive deceleration; aggressive lane changing; and aggressive following distance from vehicle ahead.

At operation 604, control of the vehicle is adapted based on the cognitive factor information. In one example, the step of adapting vehicle control comprises changing the vehicle velocity (via, for example, adjusting the throttle system 142 (FIG. 1), brakes 143, and propulsion system 146) and/or changing the steering of the vehicle (via, for example, adjusting the steering system 141), or changing another control system from vehicle systems 140.

At operation 606, the steps of obtaining and adapting are repeated to change a driving behavior of the driver. In some examples, the control of the vehicle adapts from a first driving style that is in accordance with the driving behavior of the driver, to a second driving style that is not in accordance with the driving behavior of the driver, upon the repeating of the steps of obtaining and adapting made in operation 604 above. In one example, the second driving style comprises a safer driving style than the first driving style.

In some examples, the inhibitive control information comprises an assessed level of inhibitive control of the driver. In one example, a manner of the adapting vehicle control made in operation 604 above corresponds to the assessed level of inhibitive control of the driver. For example, if a driver is determined to possess a low level of inhibitory control, the interventions can be made more obvious and appear earlier to give time for the driver to recognize the alert and adapt.

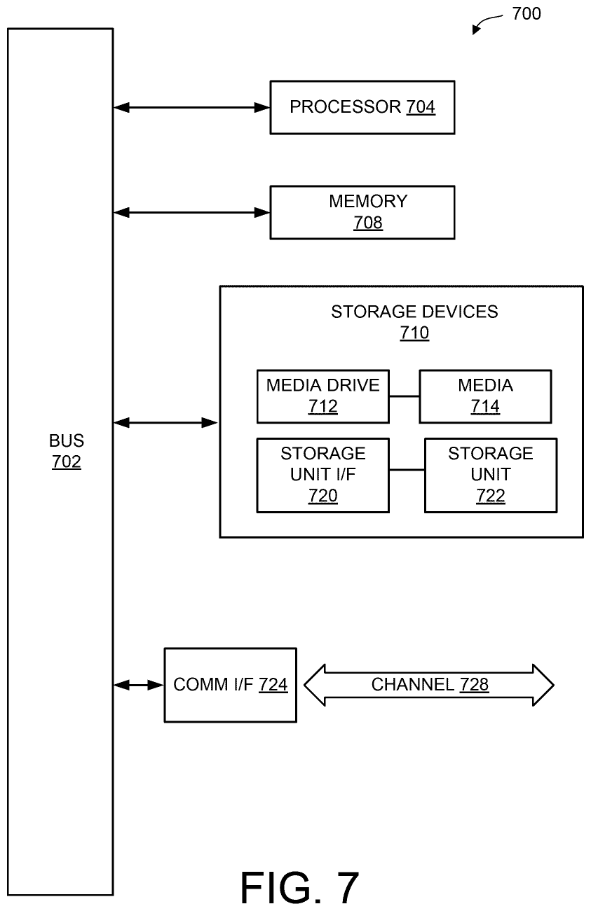

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAS, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionalities can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 7. Various embodiments are described in terms of this example-computing component 700. After reading this description, it will become apparent to a person skilled in the relevant art how to implement the application using other computing components or architectures.

Referring now to FIG. 7, computing component 700 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 700 might also represent computing capabilities embedded within or otherwise available to a given device. For example, a computing component might be found in other electronic devices such as, for example, portable computing devices, and other electronic devices that might include some form of processing capability.

Computing component 700 might include, for example, one or more processors, controllers, control components, or other processing devices, such as a processor 704. Processor 704 might be implemented using a general-purpose or special-purpose processing engine such as, for example, a microprocessor, controller, or other control logic. Processor 704 may be connected to a bus 702. However, any communication medium can be used to facilitate interaction with other components of computing component 700 or to communicate externally.

Computing component 700 might also include one or more memory components, simply referred to herein as main memory 708. For example, random access memory (RAM) or other dynamic memory, might be used for storing information and instructions to be executed by processor 704. Main memory 708 might also be used for storing temporary variables or other intermediate information during execution of instructions to be executed by processor 704. Computing component 700 might likewise include a read only memory (“ROM”) or other static storage device coupled to bus 702 for storing static information and instructions for processor 704.

The computing component 700 might also include one or more various forms of information storage mechanisms/devices 710, which might include, for example, a media drive 712 and a storage unit interface 720. The media drive 712 might include a drive or other mechanism to support fixed or removable storage media 714. For example, a hard disk drive, a solid-state drive, a magnetic tape drive, an optical drive, a compact disc (CD) or digital video disc (DVD) drive (R or RW), or other removable or fixed media drive might be provided. Storage media 714 might include, for example, a hard disk, an integrated circuit assembly, magnetic tape, cartridge, optical disk, a CD or DVD. Storage media 714 may be any other fixed or removable medium that is read by, written to or accessed by media drive 712. As these examples illustrate, the storage media 714 can include a computer usable storage medium having stored therein computer software or data.

In alternative embodiments, information storage mechanisms/devices 710 might include other similar instrumentalities for allowing computer programs or other instructions or data to be loaded into computing component 700. Such instrumentalities might include, for example, a fixed or removable storage unit 722 and an interface 720. Examples of such storage units 722 and interfaces 720 can include a program cartridge and cartridge interface, a removable memory (for example, a flash memory or other removable memory component) and memory slot. Other examples may include a PCMCIA slot and card, and other fixed or removable storage units 722 and interfaces 720 that allow software and data to be transferred from storage unit 722 to computing component 700.

Computing component 700 might also include a communications interface 724. Communications interface 724 might be used to allow software and data to be transferred between computing component 700 and external devices. Examples of communications interface 724 might include a modem or softmodem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 724 may be carried on signals, which can be electronic, electromagnetic (which includes optical) or other signals capable of being exchanged by a given communications interface 724. These signals might be provided to communications interface 724 via a channel 728. Channel 728 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 708, storage unit 722, media 714, and channel 728. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 700 to perform features or functions of the present application as discussed herein.

Although embodiments are described above with reference to a Level 3 autonomous vehicle, the autonomous vehicle described in any of the above embodiments may alternatively be a non-Level 3-type autonomous vehicle. Such alternatives are considered to be within the spirit and scope of the present invention, and may therefore utilize the advantages of the configurations and embodiments described above.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method of adapting a driver interface for a vehicle, comprising:
obtaining cognitive factor information corresponding to a driver of the vehicle; and
adapting a driver interface of the vehicle based on the cognitive factor information;
wherein the step of adapting comprises alerting the driver via an alert using the adaptive driver interface.

2. The method of claim 1, wherein the cognitive factor information comprises inhibitive control information corresponding to the driver.

3. The method of claim 2, wherein the inhibitive control information comprises an assessed level of inhibitive control of the driver.

4. The method of claim 3, wherein the alert is adaptable via a parameter selected from the group consisting of volume, brightness, contrast, color, frequency, timing, intensity, size, shape, and a combination thereof, and wherein the adaptability of the alert corresponds to the assessed level of inhibitive control of the driver.

5. The method of claim 1, wherein the alert comprises a type selected from the group consisting of audio, visual, haptic, and a combination thereof.

6. The method of claim 1, wherein the alert signals the driver to adjust control of the vehicle.

7. The method of claim 1, wherein obtaining cognitive factor information comprises a cognitive factor information acquisition scheme selected from the group consisting of receiving driving data from monitoring driving behavior of the driver, completing a questionnaire for assessing driving behavior of the driver, and a combination thereof.

8. The method of claim 7, wherein the driving behavior of the driver comprises at least one driving behavior selected from the group consisting of:
propensity to tailgate;
reaction to a traffic light;
propensity to change lanes;
lane preference;
frequency of lateral lane position shifting;
propensity to speed;
propensity to pass vehicles;
propensity to cut-off vehicles;
propensity to speed around turns;
propensity to be first to accelerate at a traffic light or sign;
aggressive acceleration;
aggressive deceleration;
aggressive lane changing;
aggressive following distance from vehicle ahead; and
a combination thereof.

9. The method of claim 1, wherein the alert is adaptable via a parameter selected from the group consisting of volume, brightness, contrast, color, frequency, timing, intensity, size, shape, and a combination thereof, and wherein the method further comprises:
determining whether the driver made a driving adjustment or whether the driving adjustment was sufficient, in response to the alert; and
adjusting the parameter of the alert to improve responsiveness of the driver in making another driving adjustment in response to the parameter-adjusted alert.

10. The method of claim 1, wherein the method further comprises repeating the steps of obtaining and adapting to change a driving behavior of the driver.

11. A vehicle control system for adapting a driver interface for a vehicle, comprising:
a processor; and
a memory coupled to the processor to store instructions, which when executed by the processor, cause the processor to perform operations, the operations comprising:
obtaining cognitive factor information corresponding to a driver of the vehicle; and
adapting a driver interface of the vehicle based on the cognitive factor information;
wherein the step of adapting comprises alerting the driver via an alert using the adaptive driver interface.

12. A method of adapting control of an autonomous vehicle, comprising:
obtaining cognitive factor information corresponding to a driver of the autonomous vehicle;
adapting control of the vehicle based on the cognitive factor information; and
repeating the steps of obtaining and adapting to change a driving behavior of the driver.

13. The method of claim 12, wherein the cognitive factor information comprises inhibitive control information corresponding to the driver.

14. The method of claim 13, wherein the inhibitive control information comprises an assessed level of inhibitive control of the driver.

15. The method of claim 14, wherein a manner of adapting control of the vehicle corresponds to the assessed level of inhibitive control of the driver.

16. The method of claim 12, wherein obtaining cognitive factor information comprises a cognitive factor information acquisition scheme selected from the group consisting of receiving driving data from monitoring driving behavior of the driver, completing a questionnaire for assessing driving behavior of the driver, and a combination thereof.

17. The method of claim 16, wherein the driving behavior of the driver comprises at least one driving behavior selected from the group consisting of:
propensity to tailgate;
reaction to a traffic light;
propensity to change lanes;
lane preference;
frequency of lateral lane position shifting;
propensity to speed in general;
propensity to exceed a speed limit;
propensity to pass vehicles;
propensity to cut-off vehicles;
propensity to speed around turns;
propensity to be first to accelerate at a traffic light or sign;
aggressive acceleration;
aggressive deceleration;
aggressive lane changing;
aggressive following distance from vehicle ahead; and
a combination thereof.

18. The method of claim 16, wherein the control of the vehicle adapts from a first driving style that is in accordance with the driving behavior of the driver, to a second driving style that is not in accordance with the driving behavior of the driver, upon the repeating of the steps of obtaining and adapting.

19. The method of claim 18, wherein the second driving style comprises a safer driving style than the first driving style.

20. A vehicle control system for adapting control of an autonomous vehicle, comprising:
a processor; and
a memory coupled to the processor to store instructions, which when executed by the processor, cause the processor to perform operations, the operations comprising:
obtaining cognitive factor information corresponding to a driver of the autonomous vehicle;
adapting control of the vehicle based on the cognitive factor information; and
repeating the steps of obtaining and adapting to change a driving behavior of the driver.
